(19) United States
(12) Patent Application Publication
(10) Pub. No.: US 2004/0060867 A1
(43) Pub. Date: Apr. 1, 2004

(54) Membrane support devices and methods of manufacturing

(75) Inventors: Leo B. Kriksunov, Ithaca, NY (US); Regina Spiehl, Skaneateles, NY (US); Joseph P. Springer, Manlius, NY (US)

Correspondence Address: OPPENHEIMER WOLFF & DONNELLY LLP, 840 NEWPORT CENTER DRIVE, SUITE 700, NEWPORT BEACH, CA, 92660, US

(73) Assignee: BMC Industries, Inc.

(21) Appl. No.: 10/313,191

(22) Filed: Dec. 6, 2002

Related U.S. Application Data
(60) Provisional application No. 60/414,371, filed on Sep. 27, 2002.

(51) Int. Cl. B01D 61/00; B01D 69/10

(52) U.S. Cl. 210/650; 210/483; 210/488

(57) ABSTRACT

Structural supports for elements, particularly supports for filtration materials and membranes, and methods of manufacturing such supports are disclosed. The membrane support structure includes one or more tapered through-holes that enable a much larger area of the membrane to be exposed to fluid flow, thereby enhancing separation processes and membrane efficiency. In addition, through-holes having smaller openings on one side of the structure produce improved support and mechanical stability/rigidity. Thus, the structural support increases the surface area of the membrane through which filtration may take place, yet preserves the mechanical strength and stability of the support structure.

### CROSS REFERENCE TO RELATED APPLICATIONS

The present application claims priority to U.S. Provisional Patent Application No. 60/414,371, filed Sep. 27, 2002, whose contents are fully incorporated herein by reference.

### BACKGROUND OF THE INVENTION

Numerous membrane separation techniques currently exist to separate or segregate substances according to molecular weight, concentration and/or size. Examples of these techniques include, but are not limited to, reverse osmosis, filtration, ultra-filtration, micro-filtration, electro-filtration, and gaseous separation processes. In general, these processes utilize gas, liquid or ionic separation membranes and/or microporous membranes in combination with pressure or concentration differentials to drive materials through the membrane. These and other filtration techniques are used in a wide variety of technologies including, but not limited to, fuel filtration, medical filtration applications, water filtration, water supply filtration, manufacturing process filtration, chemical manufacturing process filtration, and the like.

To use a membrane in these and other similar applications generally requires combining the selective membrane with a supporting porous structure. The selective membrane can be made of polymer, plastic, ceramic, composite, metal (e.g., palladium), or other materials, including combinations of materials. To facilitate the rate of separation or flux through the membrane, the membrane is fabricated as a relatively thin component. However, because of their structural configuration, thin membranes generally have poor mechanical properties and are difficult to handle and integrate into separation devices. Moreover, oftentimes thin membranes cannot withstand pressure differentials typically present across the membrane during use.

In order to overcome these problems, it is known in the art to mount the selective membrane onto a porous or perforated support structure. Such a structure provides added rigidity and mechanical stability for the membrane. In general, these support structures are typically made of a metal, ceramic or polymer substrate with a high density of holes/perforations. Further, the supports are typically fabricated as woven and non-woven meshes, perforated sheets, corrugated and embossed sheets, ribbed sheets, porous metals, porous ceramics, and other similar support structures.

Although these structures do provide mechanical support for the membrane, there are several drawbacks associated with these devices. For example, perforated or micro-porous metal supports typically tend to block a substantial part of the selective membrane. In addition, supports manufactured from sintered/porous materials and/or ribbed/corrugated materials are relatively thick and, thus, do not permit sufficient membrane flexibility. Also, in some cases, it is difficult to sufficiently seal the separation device/apparatus around the support structures resulting in reduced performance. Additional limitations of conventional support structures include high manufacturing costs, low corrosion resistance, problematic cleaning/maintenance, increased mechanical fragility, and reduced separation capabilities due to non-planar surfaces. However, the main disadvantage of perforated or micro-porous support structures is blockage of a substantial part of the selective membrane.

One example of a conventional membrane-based separation device utilizing a membrane support structure is a coil dialyzer. Coil dialyzers are generally used in artificial kidney systems and include a cylindrical-shaped shell that houses many small tubes or hollow fibers placed between support screens that are tightly wound around a plastic core. The hollow fibers are made of a semipermeable membrane that filters waste products from the blood into the dialysate. In particular, blood from a patient flows through the dialyzer inside the membrane and dialysis solution flows though the dialyzer in a crosswise direction. The dialysis solution flows between and contacts the windings of the membrane and support member to remove waste products from the blood.

Early coil designs, such as those disclosed in Metz (U.S. Pat. No. 2,880,501) and Broman (U.S. Pat. No. 2,969,150), of which both patents are incorporated herein by reference, utilize fiber glass screens as supports for the flattened tubular membranes. In particular, the flat cellulose (membrane) tubes are enveloped between nontoxic fiber glass screens and the resulting assembly is then tightly but uniformly coiled about itself. The coiled structure also includes suitable connections leading from and to the body of the patient to be treated.

A significant improvement in commercial dialyzer coil designs occurred through the use of a non-woven plastic mesh or netting as a membrane support structure. For example, Miller (U.S. Pat. No. 3,508,662, incorporated herein by reference) discloses an artificial kidney coil unit comprising an inner core with a single elongated tubular membrane and a single length of membrane supporting mesh spirally wrapped in sandwiched relationship to each other around the core. The improved orientation of the non-woven strands of the mesh facilitates flow through the spiral blood passage and, thereby, provides uniform fluid pathways.

Hoeltzenbein (U.S. Pat. No. Re. 27,510, issued Oct. 24, 1972, and incorporated herein by reference) also discloses an improved membrane support structure formed of porous tie-bands or wire nettings. The tie-bands are coiled with dialysis membrane tubing on a common core in a manner that produces a dialyzer coil configured as a multiple-start spiral design. This novel arrangement increases blood flow through the assembly and greatly enhances the dialysis effect.

Another example of an improved mesh or netting support structure is disclosed in U.S. Pat. No. 3,709,367 (issued to Martinez and incorporated herein by reference). This membrane support structure is also configured as a netting or screen made of individual fibers or strands. However, unlike the prior art strands that are circular or cylindrical in shape, the strands of the Martinez device are formed such that they are non-circular in cross-section. As a result, the Martinez design produces less masking of the dialyzing membrane and, thus, provides for greater efficiency of the dialysis device.

One problem associated with the above-described mesh support structures involves the configuration of the screening strands in the coil dialyzer. In particular, the volume of blood in the dialysis tubing is higher than desirable if the screening strands are spaced apart widely enough to reduce the pressure to desired levels. In general, it is desirable for the blood volume of the dialyzer to be at an absolute minimum. One solution to address this problem involves a foraminous screen member that supports or lies against a length of semipermeable membrane having a flattened tubular shape, as disclosed in U.S. Pat. No. 3,743,098 and incorporated herein by reference. This particular arrangement reduces the back pressure encountered by blood passing through the dialysis tubing while at the same time maintaining blood volume within the dialysis tubing at a minimum.

Recently, more efficient devices have replaced the coil dialyzer design. For example, one alternate dialyzer design includes embossed support members having an imperforate center and equal-height support ribs. The ribs engage and position the membrane in the dialyzer, as well as define the flow channels between the support member and membrane for the dialysis solution. This design allows multiple parallel blood and dialysate flow channels having a lower resistance to flow which, thereby, produces more uniform dialysate flow distribution across the membrane.

Another example of a conventional membrane-based separation device utilizing a membrane support structure is an electrolyzer. An electrolyzer separates hydrogen from oxygen by applying an electrical current to water. U.S. Pat. No. 5,372,689, incorporated herein by reference, describes a water electrolyzer, comprising an ion exchange membrane disposed between an anode electrode and a cathode electrode. In addition, a porous sheet is also included to provide additional structural integrity to the ion exchange membrane while allowing dual-directional flow of water to the anode electrode.

Alternate support structures and methods of manufacturing support members for semi-permeable membranes are disclosed in U.S. Pat. Nos. 4,009,107, 4,115,273, and 4,225,438, which are incorporated herein by reference. As noted in these references, blocking of the membrane by perforated supports results in decreased membrane efficiency, as blocked areas are unable to participate in the separation process. Therefore, there is a need for an inexpensive support that does not impede or restrict flow through the membrane.

In view of the above, there is a need for a membrane support device and method of stabilizing a selective separation membrane. In particular, it is desirable that the device provides sufficient support, mechanical stability and flexibility to the membrane. It is also desirable that the device increases membrane efficiency and minimizes the blocked area of the selective separation membrane. In addition, the membrane support designs should be uniform, cost effective, and easy to use and fabricate.

### BRIEF SUMMARY OF THE INVENTION

In general, the present invention contemplates support structures and methods of manufacturing support members for selective separation membranes. The device comprises a micro-etched or micro-perforated plate or foil with a specific format of tapered apertures. The apertures have larger openings in the support material on the side of the support facing the membrane then on the side of the support facing away from the membrane. This increases the surface area of the membrane that is available to work when in contact with fluids, while preserving as much mechanical strength in the supporting structure as possible.

The present invention also contemplates a membrane support structure comprising a structural element having a first surface, a second surface and one or more through-holes formed in the structural element. In addition, the through-holes include dissimilar sized openings on the first and second surfaces connected by a channel extending along a thickness of the structural element.

The present invention also contemplates a membrane support device comprising a flexible membrane and a structural element located adjacent the flexible membrane to support the flexible membrane. The structural element includes a first surface having a plurality of openings and a second surface in contact with the flexible membrane and opposing the first surface. In addition, the second surface includes a plurality of openings, wherein the openings on the second surface are larger than the openings on the first surface. Further, a plurality of channels extends through the structural element and connects respective openings on the first surface and the second surface to allow fluid flow through the device.

The present invention also contemplates a support structure comprising a structural element wherein a thickness of the structural element is approximately within the range of 10 to 3000 microns. In addition, the support structure may also include a plurality of openings wherein each opening on a second surface of the structural element is approximately within the range of 30 to 1000 microns in diameter. Further, each opening on the first surface is approximately within the range of 20 to 900 microns in diameter.

The present invention further contemplates a method of manufacturing a membrane support device comprising providing a structural element having a first surface and a second surface and forming a plurality of openings on the first surface. The method further includes forming a plurality of openings on the second surface, wherein the openings on the second surface are larger than the openings on the first surface. In addition, the method includes creating channels extending between the openings of the first and second surfaces and providing a flexible membrane, wherein the flexible membrane contacts the second surface and is mechanically supported by the structural element.

The present invention further contemplates a method of separating a fluid substance comprising providing a separation membrane assembly and causing the fluid substance to traverse a separation membrane of the assembly prior to encountering the support structure, wherein a planar surface area of openings in a first side of the support structure is less than a planar surface area of openings in a second side of the support structure. The method also includes continuing a flow of the fluid substance through a separation membrane so as to separate the fluid substance into desired parts.

### BRIEF DESCRIPTION OF THE DRAWINGS

Other features and advantages of the present invention will be seen as the following description of particular embodiments progresses in conjunction with the drawings, in which:

FIGS. 1A-1D show top and sectional views of prior art support devices;

FIG. 2A illustrates a sectional view of an embodiment of a membrane support structure in accordance with the present invention;

FIG. 2B illustrates a top view of the membrane support structure of FIG. 2A;

FIG. 3 illustrates a sectional view of another embodiment of a membrane support structure in accordance with the present invention;

FIGS. 4A and 4B illustrate sectional views of alternate embodiments of a membrane support structure in accordance with the present invention;

FIG. 5 illustrates a sectional view of another embodiment of a membrane support structure in accordance with the present invention;

FIG. 6A shows the distal surface of an embodiment of a membrane support structure in accordance with the present invention;

FIG. 6B shows the proximal surface of the membrane support structure of FIG. 6A;

FIG. 6C shows the distal surface of another embodiment of a membrane support structure in accordance with the present invention;

FIG. 6D shows the proximal surface of the membrane support structure of FIG. 6C;

FIG. 7A shows the proximal surface of another embodiment of a membrane support structure in accordance with the present invention;

FIG. 7B shows the distal surface of the membrane support structure of FIG. 7A;

FIGS. 8A and 8B illustrate various stages of an etching method used to create an embodiment of a membrane support structure in accordance with the present invention;

FIG. 9 illustrates an alternate embodiment of a membrane support structure in accordance with the present invention;

FIGS. 10A and 10B illustrate various stages of a drilling method used to create an embodiment of a membrane support structure in accordance with the present invention; and

FIG. 11 illustrates an alternate drilling method used to create an embodiment of a membrane support structure in accordance with the present invention.

### DETAILED DESCRIPTION OF THE INVENTION

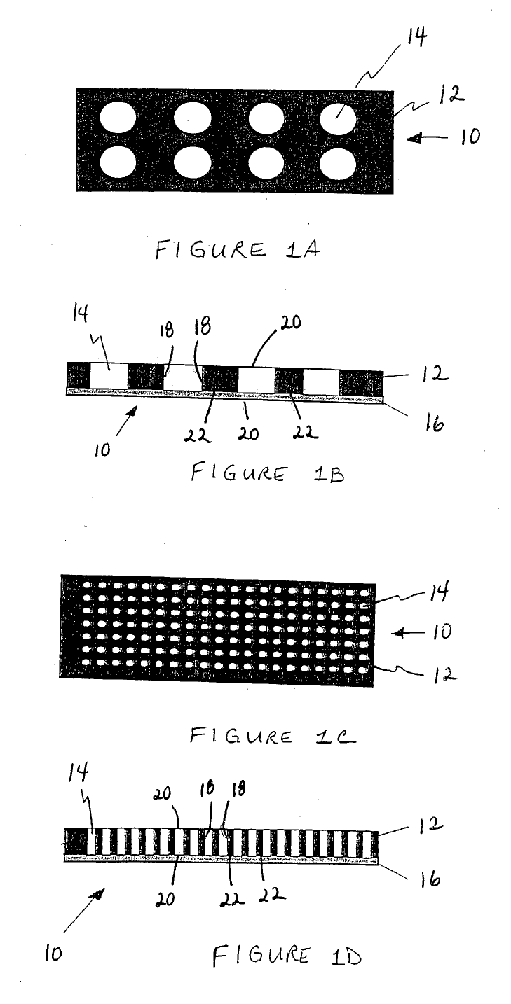

FIGS. 1A-1D illustrate two embodiments of conventional membrane support structure assemblies 10. In general, the assemblies 10 include a structural sheet material 12, having a plurality of through-holes or pores 14 formed within the sheet material 12, and a selective separation membrane 16 located adjacent the sheet material 12. The sheet material 12 is configured to provide structural support to the membrane 16 and allow fluid to flow through the pores 14 of the membrane 16.

As shown in FIGS. 1B and 1D, the through-holes 14 of the sheet material 12 tend to be cylindrical in shape with uniformly sized walls 18 and openings 20 on both surfaces of the sheet material 12. Each opening 20 is distributed at substantially equal distances from adjacent openings 20 on the sheet material 12 to provide structural support to the flexible membrane 16. However, as noted in the Background of the Invention, membrane areas 22 blocked by the sheet material 12 impede or restrict flow through the membrane 16. As a result, there is an overall decrease in membrane efficiency with these prior art devices 10 since the blocked areas 22 are unable to participate in the separation process.

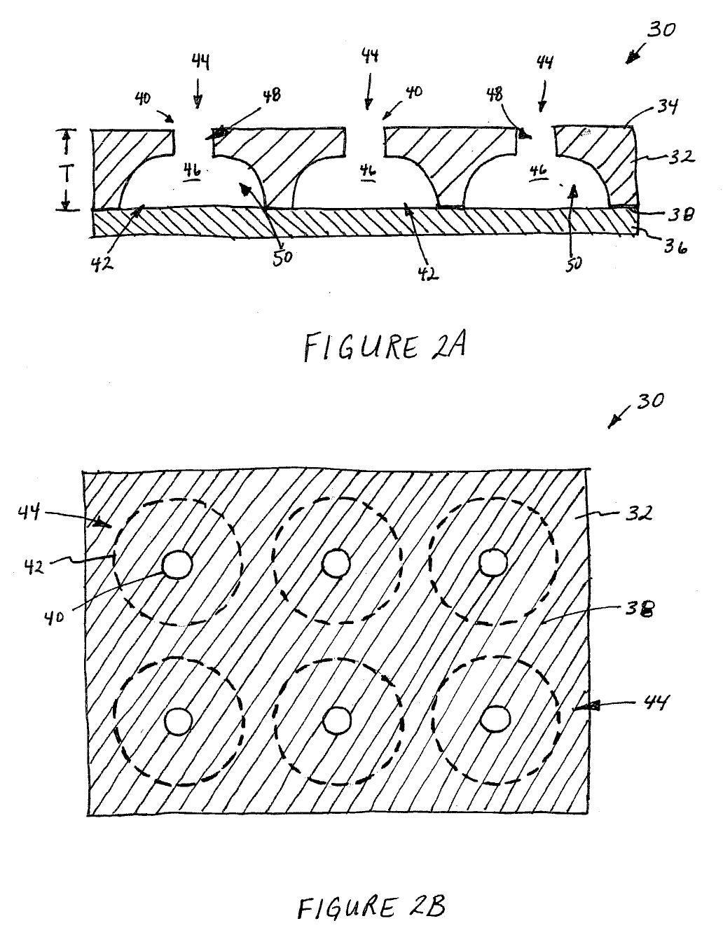

As the present invention substantially eliminates these undesirable characteristics, it is instructive to describe the support device of the present invention that provides sufficient membrane support and superior membrane efficiency compared to prior art devices. For this purpose, reference is made to FIGS. 2A and 2B.

Device Configuration

FIGS. 2A and 2B illustrate one embodiment of a membrane support structure 30 of the present invention. In general, the support structure 30 comprises a relatively planar structural element 32, such as that derived from a plate, film or sheet, having at least two surfaces. The first or distal surface 34 is the surface that is farthest from the membrane or member 36 braced by the support structure 30. The second or proximal surface 38 is the surface that is in direct communication with the membrane or member 36 supported by the structure 30. Although the term membrane is used throughout this description, it is understood that the scope of the claimed invention is not limited to membranes and includes other separation elements know to those skilled in the art.

The two surfaces 34, 38 define in part the overall thickness T of the support structure 30, which is configured to the application and/or physical requirements of the device. In one embodiment of the invention, the thickness T of the support structure 30 is approximately within the range of 5 to 500 microns. In general, the support structure 30 may range from a few microns (e.g., 5 microns) to a few millimeters (e.g., 5 millimeters) in thickness T, although other thicknesses are also included within the scope of the claimed invention.

A variety of materials, including combinations of materials, may be used to fabricate the support structure 30 of the present invention. Examples of these materials include metals (e.g., iron and iron alloys, stainless steel, nickel, titanium, aluminum, Al/Cr/Fe steel, copper, brass, bronze, Nitinol™, etc.), inorganic oxides (e.g., alumina, silica, titania, zirconia, etc.), metallized surfaces, plastics, ceramics, polymeric materials, composite materials and other materials, including combinations of materials, not mentioned herein but known to those skilled in the art. Depending on the particular application for which the support structure 30 is used, the materials of the support structure 30 should generally provide sufficient strength and structural integrity to adequately support the membrane 36 and not impair the filtration process. Although the invention as disclosed herein generally refers to filtration, other techniques including, but not limited to, reverse osmosis, ultra-filtration, micro-filtration, electro-filtration and gaseous separation processes are also included within the scope of the claimed invention.

As will be clear from the discussion below, the support element 30 is configured to allow a sufficient flow of fluid through the support structure 30 from the distal surface 34 to the proximal surface 38 or vice versa. In this regard, one or more pores, through-holes or openings are formed on both the distal 34 and proximal 38 surfaces of the support structure 30.

Referring to FIG. 2A, in addition to dissimilar sized openings 40, 42 on the distal 34 and proximal 38 surfaces, which will be described in further detail below, each through-hole 44 further includes a tapered channel 46 that extends along the thickness T of the support structure 30. A first portion 48 of the channel 46 located adjacent to the distal surface 34 of the support structure 30 is generally cylindrical in shape, whereas a second portion 50, located adjacent to the proximal surface 38, is hemi-spherically shaped. This configuration not only provides increased membrane surface area exposure, but also improved mechanical stability.

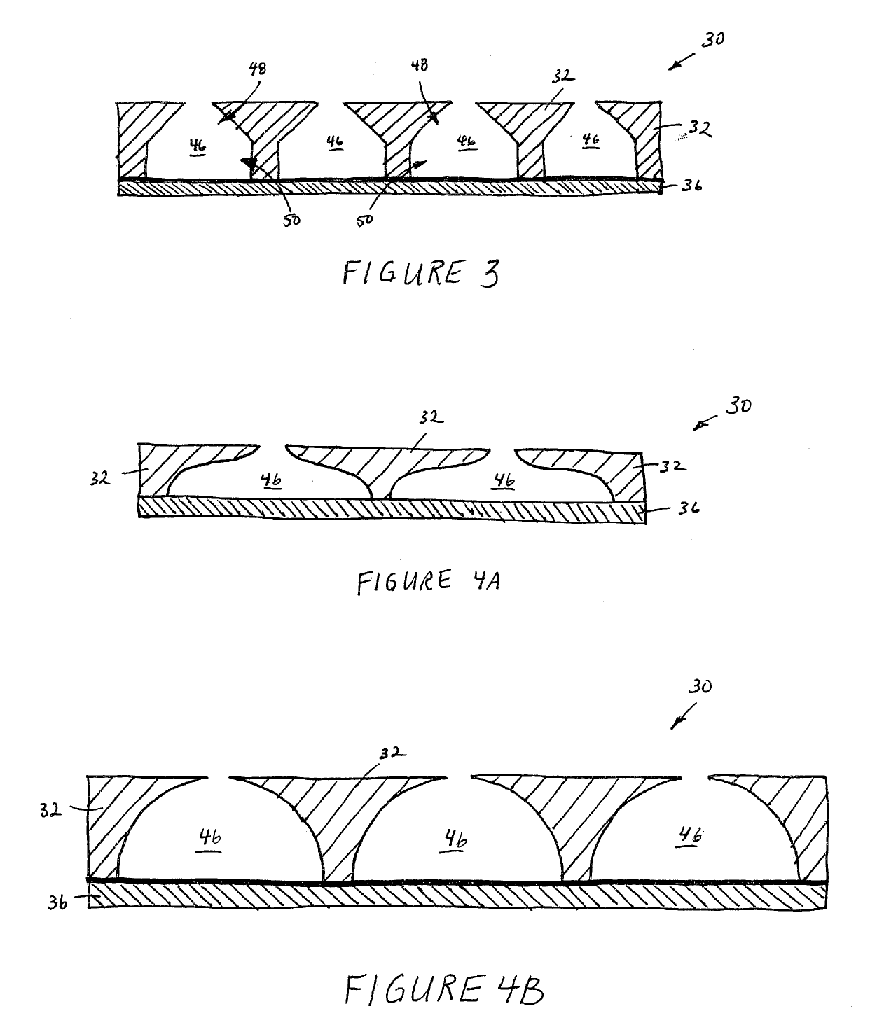

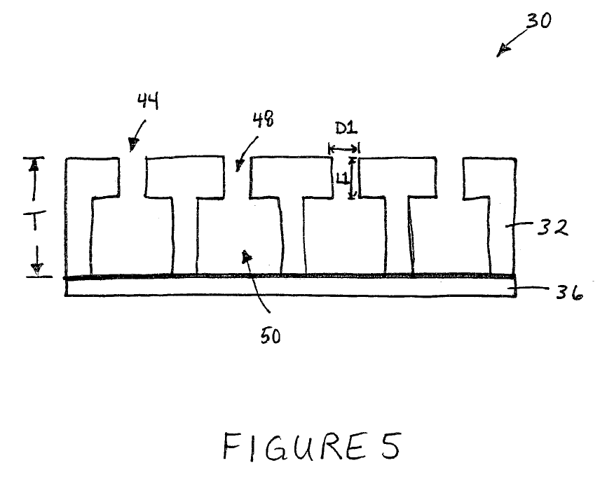

Alternate embodiments of the through-hole 44 are shown in FIGS. 3, 4A and 4B. In this regard, FIG. 3 illustrates a cross-sectional view of a through-hole channel 46 having a shape similar to that of the bottom-half of an hourglass. In other words, the first portion 48 is frusto-conically shaped and the second portion 50 of the channel 46 is cylindrically shaped. In contrast, FIGS. 4A and 4B illustrate cross-sectional views wherein the entire through-hole channel 46 is generally hemi-spherically shaped.

Additional configurations of the through-hole channel 46 include, for example, cylindrically shaped first 48 and second 50 portions that are coaxially aligned along the length of the through-hole 44. As shown in FIG. 5, the diameter D1 and length L1 of the first cylindrical portion 48 of the through-hole 44 may be approximately 0.10 mm and 25% of the thickness T of the support structure 30, respectively. Further, the related dimensions for the second portion 50 of the cylindrical through-hole 44 may be approximately 0.30 mm in diameter and 75% of the thickness T of the support structure 30. It should be noted these percentages and diameters are merely illustrative and are not to be considered as limiting. Moreover, alternate through-hole channel configurations, not specifically disclosed herein but known to those skilled in the art, are also included within the scope of the claimed invention.

As referenced above, the support structure 30 of the present invention includes dissimilar sized openings or pores 40, 42 on the distal 34 and proximal 38 surfaces that are circular in shape. In one embodiment, the diameter of the pores 40 on the distal surface 34 of the support structure 30 is approximately within the range of 25 to 100 microns. In contrast, the diameter of the pores 42 on the proximal surface 38 of the support structure 30 is approximately within the range of 100 to 600 microns. This configuration of the support structure 30 increases membrane surface area exposure and, thereby, enhances membrane filtration, as explained in further detail below.

In another embodiment of the invention, the support structure 30 is configured so that the total area of material on the distal surface 34 of the support structure 30 is at least 10% greater than the total area of material on the proximal surface 38. To the extent the surfaces of the support structure are defined in terms of material and openings, it follows that the surface having the greatest amount of total material thereby also has the least amount of total openings/pores. Thus, for this embodiment of the invention, the proximal surface 38 of the support structure 30 has a total area of openings 42 that is at least 10% greater than the total area of openings 40 on the distal surface 34 of the support structure 30. As a result, the membrane or element 36 being supported by the structure 30 contacts the surface of the support structure 30 having the greatest area of openings.

In an alternate configuration, the total area of openings 42 on the proximal surface 38 is at least 15% greater than the total area of openings 40 on the distal surface 34. In yet another embodiment of the invention, the total area of openings is 20% greater on the proximal surface 38 compared to the distal surface 34 of the support structure 30. In general, additional embodiments of the invention may be configured so that the difference between the total area of the openings 42 on the proximal surface 38 and the total area of the openings 40 on the distal surface 34 is approximately within the range of 5% to 95%. Maximizing the total open area of the pores on the proximal surface 38 of the support structure 30 not only allows the membrane 36 to have the greatest exposed surface area but, thereby, also enhances membrane filtration, as further discussed below.

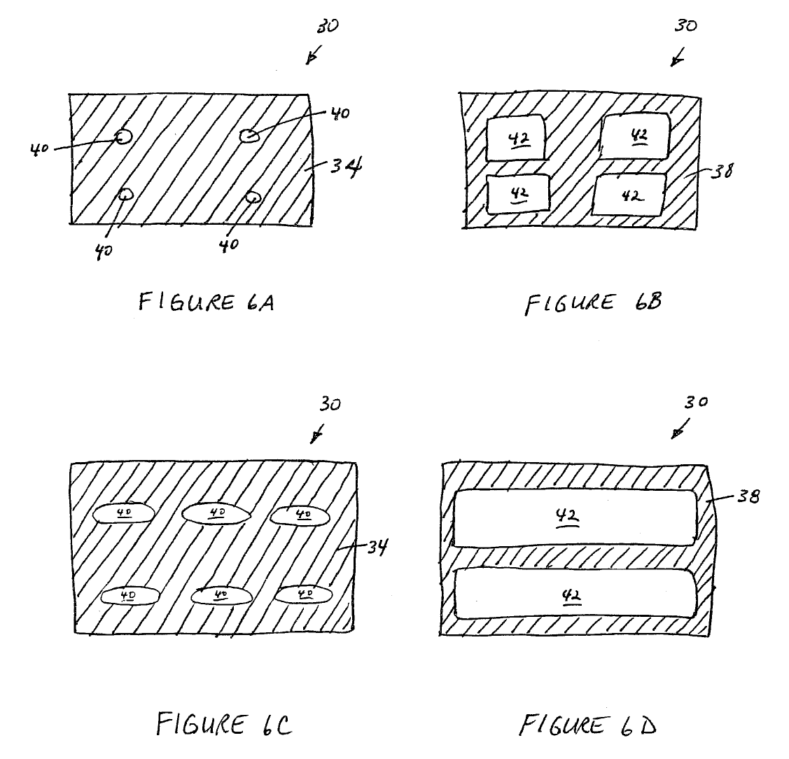

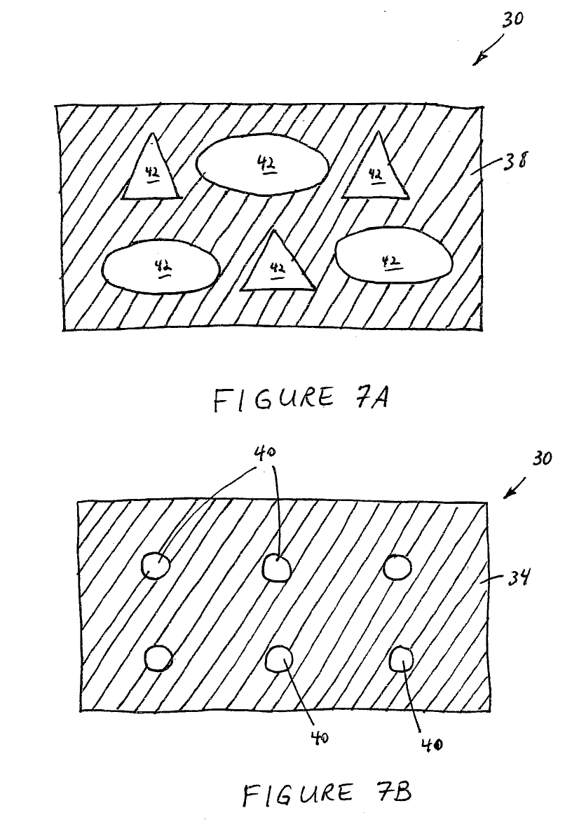

Although the pores or openings 40, 42 of the support structure 30 have been referred to as being circular in shape, alternate shapes of the openings 40, 42 are also included within the scope of the claimed invention. Examples of these shapes include, but are not limited to, oval, square, rectangular, oblong, triangular, polygonal and curvilinear. In addition, the support structure 30 may also include pores 42 on the proximal surface 38 that have a first shape and pores 40 on the distal surface 34 that have a second shape. Further, pores 42 on the proximal surface 38 may be shaped the same as or differently from pores 40 on the distal surface 34 of the support structure 30. For example, as shown in FIGS. 6A and 6B, the pores 42 on the proximal surface 38 are square-shaped and the pores 40 on the distal surface 34 are circular in shape. Another example of a support structure 30, illustrated in FIGS. 6C and 6D, includes pores 42 on the proximal surface 38 that are rectangular in shape and pores 40 on the distal surface 34 that are oval in shape.

In another embodiment, the support structure 30 may include pores having more than one shape on a single surface. In other words, a surface on the support structure may include a combination of pore shapes. For example, referring to FIGS. 7A and 7B, the proximal surface 38 of the support structure 30 in this embodiment of the invention includes a combination of triangular pores 42 and oval pores 42, whereas the distal surface 34 includes only circular-shaped pores 40. Additional configurations of support structure pores/openings, not specifically disclosed herein but known to those skilled in the art, are also included within the scope of the claimed invention.

In general, maximizing the difference between the open areas on the proximal and distal sides 38, 34 of the support structure 30, as described above, effectively optimizes the support and separation capabilities of the device of the present invention. In particular, the amount or overall area of membrane 36 blocked by support structure material is reduced due, in part, to the unique structure or configuration of the open areas 40, 42. At a minimum, these features maximize functional contact between the membrane 36 and support structure 30 and allow for an improved flow of fluid from the distal side 34 to and through the proximal side 38, or vice versa, of the support structure 30. As a result, there is an overall increase in membrane efficiency since the blocked areas, which are unable to participate in the separation process, are minimized and the exposed areas are maximized.

In addition to increasing membrane efficiency, the support structure 30 of the present invention also provides the structural strength required to sufficiently support a membrane 36 during use of the device. Further, although numerous examples of support structure configurations have been disclosed, the above-described features of the support structure of the present invention may be further optimized or tailored to accommodate particular membrane and application requirements. These additional embodiments, not described herein but known to those skilled in the art, are also included within the scope of the claimed invention.

Manufacturing Methods

The support structure 30 of the invention may be made by any number of available process technologies and combinations of shaping and/or etching technologies. Examples of technologies that may be used to form the through-holes 44 in the support structure 30 include, but are not limited to, etching (including mask etching, photolithographic etching, chemical etching, stencil etching, electrochemical etching, and the like), electroforming or electroplating, machining (e.g., shaped drilling, mechanical milling, electrical discharge milling, and other physical shaping and cutting processes), laser ablation, stamping, punching, embossing, casting, molding and any combination of such methods.

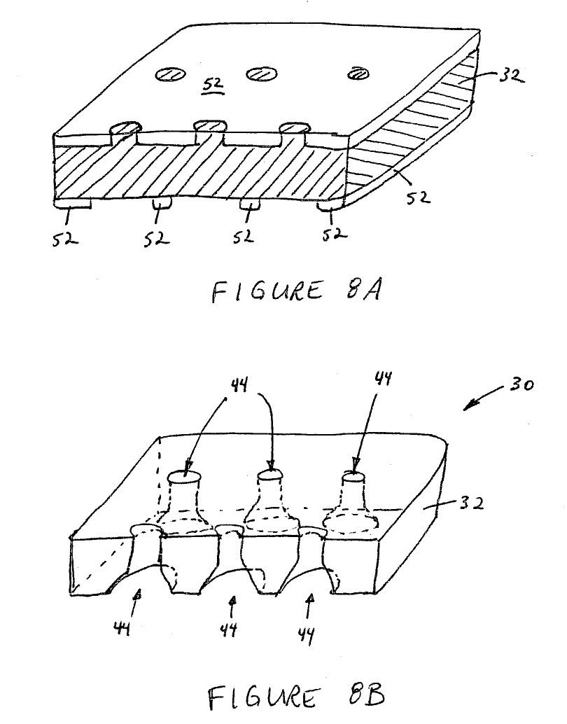

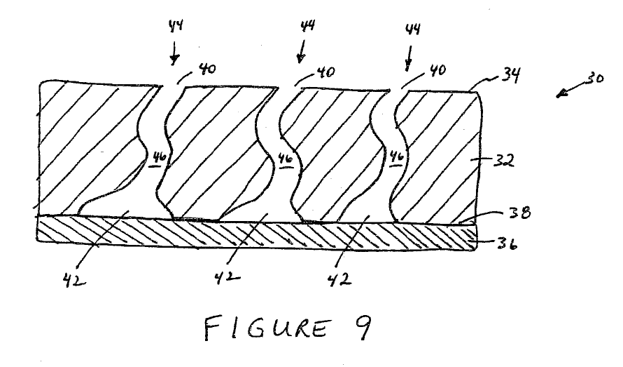

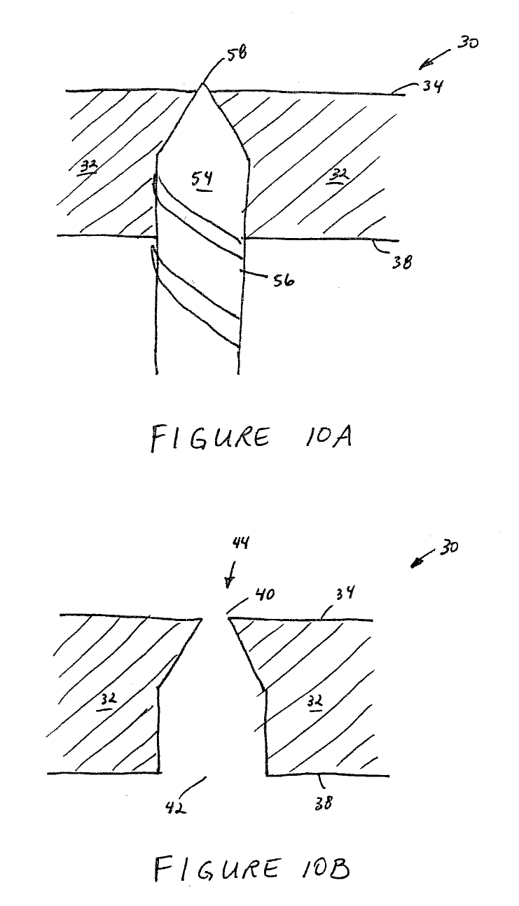

One type of etching or photochemical machining process used to manufacture the membrane support structure 30 is two-sided etching. For this method, a sheet, film, foil, web or similar material (hereinafter referred to as a “sheet”) is selected based upon the desired material composition for the membrane support structure 30. As shown in FIG. 8A, a patterned photoresist or other similar product 52 is applied, for example via imaging, to protect or mask those areas on both sides/surfaces of the sheet 32 against the etchant. In other words, the photoresist 52 creates a template on each surface that will ultimately produce the desired configuration of through-holes 44 in the support structure 30.

After the patterned photoresist 52 is applied and cured, each surface of the sheet 32 is then chemically etched to remove material from all unmasked areas of the sheet 32. Etching may be performed in a single step, two-sided etching process, wherein both sides/surfaces of the sheet 32 are simultaneously etched, or in a two-step process, wherein, during the first step, etching is applied to one or both sides of the sheet and, during the second step, etching is performed on a single side or both sides of the sheet. A second etching applied to only one surface of the sheet 32 generally follows the first process in order to create the desired through-hole design. Alternatively, various combinations and alternate techniques of etching processes may also be used to form the desired configuration of through-holes in the sheet/support structure, as shown in FIG. 8B.

As described above, the shape or pattern of the mask dictates the resulting shape of the etched areas of the sheet 32 and, together with the degree of etching, the shape of the resulting through-hole 44. For example, with respect to the membrane support structure of the present invention, the holes 40 in the mask pattern on the distal side 34 of the sheet 32 would be smaller than the corresponding holes 42 in the mask pattern on the proximal side 38 of the sheet 32.

In one embodiment of the invention, the opposed holes 40, 42 on the support structure 30, even if different in size, are in alignment and approximately share a coaxial center. In other words, a line perpendicular to the plane of the sheet surface and passing through the geometric center of the hole 42 in the proximal surface 38 would also pass approximately through the geometric center of the hole 40 in the distal surface 34. As a result, this through-hole configuration produces a substantially straight flow path through the distal surface to the proximal surface of the support structure 30.

Depending on the membrane type and application requirements, a less direct flow path through the support structure 30 may be desired. As shown in FIG. 9, the through-holes 44 of the support structure 30 include off-center openings 40, 42 and tortuous channels 46 to deflect flow in passing from the distal surface 34 to the proximal surface 38 of the device 30 or vice versa.

Additional etching techniques employing a mechanical mask (e.g., a stencil), an applied mask (e.g., inks or discontinuous coatings), or a photolithographically applied mask of either negative or positive resist material(s) may also be used to produce the support structure 30 of the present invention. For example, this technique involves applying either a positive-acting or negative-acting photosensitive resist layer to each surface 34, 38 of the sheet 32. The resist layer is radiation exposed through a patterned artwork which creates the desired hole pattern for the membrane support structure 30. Following radiation exposure, the resist layer is developed to remove the more soluble areas and produce a mask of the desired pattern, size, and shape of openings 40, 42 on the support structure surfaces. Conventional etching techniques may then be used to etch the openings 40, 42 and produce the desired shape of through-holes 44. It is well known in the etching art to vary etch compositions, temperatures, liquid flow patterns and the like to provide subtle shaping variations, such as etching slope, undercutting and other effects, in the etch process. As such, these techniques and their variations are also included within the scope of the claimed invention.

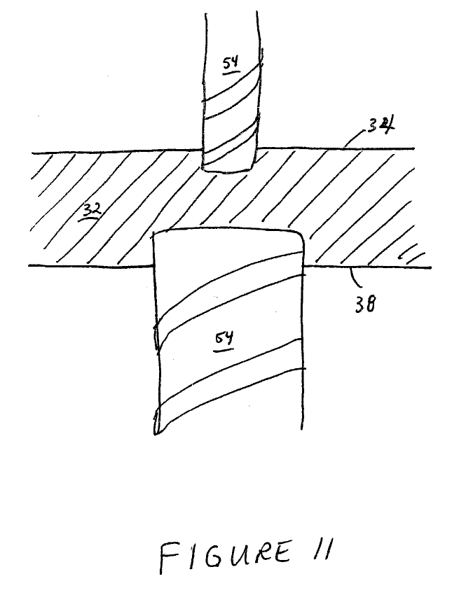

Shaped or one-sided drilling is another method used to manufacture the support structure 30 of the present invention. In one embodiment, a drill bit 54 having a pyramidal shape is used to drill pyramidal-shaped through-holes 44 in the support structure 30. This method requires that the drill bit 54 enters through the proximal surface 38 of the support structure 30 and continues to bore through the structure 30 until the tip of the bit 54 breaks through the distal surface 34. At this point, shown in FIG. 10A, the base 56 of the drill bit that is cutting into the proximal surface 38 is wider than the tip 58 of the drill-bit 54 that is cutting into the distal surface 34. The drill bit 54 is then backed-out of the opening 44 so that the drilled shape in the support structure 30 corresponds to the desired through-hole shape. As shown in FIG. 10B, the resulting through-hole 44 has the desired wider opening 42 on the proximal surface 38 and smaller opening 40 on the distal surface 34 of the support structure 30, which enhances membrane efficiency as previously described. Additional manufacturing methods, such as an after burnishing or etching method, may be used in combination with the shaped drilling method to smooth rough surfaces or remove any imperfections.

Referring back to FIG. 5, this embodiment of the support structure 30 may be produced using a two-sided drilling method. As shown in FIG. 11, two, separately sized drill bits 54 are used to form their respective portions of each through-hole 44. In this regard, the smaller sized drill bit 54 enters from the distal surface 34 and the larger sized drill bit 54 enters from the proximal surface 38. The bits 54 bore through the support material to a depth that will produce the desired through-hole configuration, shown in FIG. 5. Although the drill bits and resulting through-hole shown in FIGS. 5 and 11 are cylindrically shaped, additional shapes (as discussed above) known to those skilled in the art may also be used and are also included within the scope of the claimed invention.

Yet another method that may be used to manufacture the support structure 30 of the present invention is electrical discharge machining. In general, electrical discharge machining (EDM) uses pulses or sparks of electricity emitted from an electrode to etch or evaporate material. The electrode is positioned over a target area and an electrical discharge is generated by a power supply that destroys/removes the targeted material. Additional areas of material are removed by moving the electrode over each targeted area until the desired opening or through-hole shape is formed in the support structure 30.

Almost any type of through-hole configuration can be manufactured using EDM techniques. This is accomplished, in part, by controlling the strength/intensity of the electrical pulse, the length of time that the electrode is positioned over a particular area and movement of the electrode in relation to the workpiece/sheet 32. As such, the desired configuration of the through-hole 44, including the shape of the channel 46 and the size of the openings 40, 42 on both surfaces 34, 38, can be precisely and accurately produced.

Although EDM machining is a very precise method that can produce very intricate shapes, it is also a relatively slow and time-consuming method. As such, etching through a sheet 32 or other support structure material requires positioning the electrode for a significant amount of time at each target area on the sheet 32. Alternatively, a relatively faster method that may be used is sputter etching. In general, sputter etching methods may be used in a similar process to remove material and produce a through-hole 44 in the support structure 30, including the shape of the channel 46 and the size of openings 40, 42 at both surfaces 34, 38 of the structure 30.

In summary, the membrane support structure 30 of the present invention substantially eliminates undesirable characteristics generally associated with prior art support structures. As described above, tapered through-holes 44 enable a much larger area of the membrane 36 to be exposed to fluid flow, thereby enhancing separation processes and membrane efficiency. In addition, through-holes 44 having smaller openings 40 on one side 34 of the structure 30 provide sufficient support and mechanical stability/rigidity to the membrane 36. Thus, the device 30 of the present invention increases the amount of exposed surface area of the membrane 36 through which filtration may take place, yet preserves the mechanical strength and stability of the support structure 30. Additional advantages of the present invention include the ability to configure the membrane 36 and/or support structure 30 into any planar or non-planar form (e.g., coiled, tubular, corrugated, etc.), sufficiently seal the separation device/apparatus around the support structure 30, increase pressure resistance, improve flexibility and mechanical stability, increase corrosion resistance, and create uniform and cost effective membrane support designs that are easy to use and fabricate.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A membrane support structure comprising:
a structural element having a first surface, a second surface and one or more through-holes formed in said structural element, wherein said through-holes include dissimilar sized openings on said first and second surfaces connected by a channel extending along a thickness of said structural element.

2. The membrane support structure of claim 1 wherein said openings on said first surface are smaller than said openings on said second surface.

3. The membrane support structure of claim 1 wherein said channel is tapered.

4. The membrane support structure of claim 1 wherein a first portion of said channel is located adjacent said first surface and a second portion of said channel is located adjacent said second surface.

5. The membrane support structure of claim 4 wherein said first portion is generally cylindrical in shape.

6. The membrane support structure of claim 4 wherein said second portion is hemi-spherically shaped.

7. The membrane support structure of claim 4 wherein said first and second portions are coaxially aligned along a length of said channel.

8. The membrane support structure of claim 1 wherein a total area of openings on said second surface is at least 10% greater than a total area of openings on said first surface.

9. A membrane support device comprising:
a flexible membrane; and
a structural element located adjacent said flexible membrane to support said flexible membrane, wherein said structural element includes;
a first surface having a plurality of openings;
a second surface in contact with said flexible membrane and opposing said first surface, said second surface having a plurality of openings, wherein said openings on said second surface are larger than said openings on said first surface; and
a plurality of channels extending through said structural element and connecting respective openings on said first surface and said second surface to allow fluid flow through said device.

10. The membrane support device of claim 9 wherein a total area of openings on said second surface is at least 10% greater than a total area of openings on said first surface.

11. The membrane support device of claim 9 wherein said openings are configured to increase and optimize membrane efficiency.

12. The membrane support device of claim 9 wherein a thickness of said structural element is approximately within the range of 10 to 3000 microns.

13. The membrane support device of claim 9 wherein each opening on said second surface is approximately within the range of 30 to 1000 microns in diameter.

14. The membrane support device of claim 9 wherein each opening on said first surface is approximately within the range of 20 to 900 microns in diameter.

15. A method of manufacturing a membrane support device comprising:
providing a structural element having a first surface and a second surface;
forming a plurality of openings on said first surface;
forming a plurality of openings on said second surface, wherein said openings on said second surface are larger than said openings on said first surface;
creating channels extending between said openings of said first and second surfaces; and
providing a flexible membrane, wherein said flexible membrane contacts said second surface and is mechanically supported by said structural element.

16. The method of claim 12 wherein said openings are made via photochemical machining.

17. The method of claim 12 wherein said openings are made via chemical etching.

18. The method of claim 12 wherein said channels are made via photochemical machining.

19. The method of claim 12 wherein said channels are made via chemical etching.

20. A method of separating a fluid substance comprising:
providing a separation membrane assembly;
causing said fluid substance to traverse said separation membrane of said assembly prior to encountering a support structure, wherein a planar surface area of openings in a first side of said support structure is less than a planar surface area of openings in a second side of said support structure; and
continuing a flow of said fluid substance through said separation membrane so as to separate said fluid substance into desired parts.
